(19) United States
(12) Patent Application Publication
(10) Pub. No.: US 2019/0180679 A1
(43) Pub. Date: Jun. 13, 2019

(54) DISPLAY CALIBRATION TO MINIMIZE IMAGE RETENTION

(71) Applicant: Google LLC, Mountain View, CA (US)

(72) Inventors: Wonjae Choi, San Jose, CA (US); Ken Foo, Sunnyvale, CA (US); John Kaehler, Mountain View, CA (US)

(21) Appl. No.: 16/217,792

(22) Filed: Dec. 12, 2018

Related U.S. Application Data
(60) Provisional application No. 62/597,742, filed on Dec. 12, 2017.

(51) Int. Cl. G09G 3/3225

(52) U.S. Cl. CPC G09G 3/3225; G09G 2320/0693; G09G 2320/0295; G09G 2320/0257

(57) ABSTRACT

Methods, systems, and apparatus, including computer programs encoded on computer storage medium, for calibrating a display to minimize the effect of image retention are disclosed. In one aspect, a method is disclosed that includes obtaining data representing a current state of pixels in a first region of a display of the user device, determining a current pixel calibration associated with the first region of the display of the user device, determining a difference between the current pixel calibration and an initial pixel calibration for the pixels in the first region of the display of the user device, and adjusting a calibration of pixels in a second region of the display of the user device based on the determined difference between the current pixel calibration and an initial pixel calibration for the pixels in the first region of the display of the user device.

### CROSS-REFERENCE TO RELATED APPLICATIONS

This application claims the benefit of U.S. Provisional Patent Application No. 62/597,742 filed Dec. 12, 2017 and entitled “Display Calibration To Minimize Image Retention,” which is incorporated herein by reference in its entirety.

### BACKGROUND

A common problem for displays such as Organic Light-Emitting Diode (“OLED”) displays is image retention, commonly referred to as “burn-in.” Image retention can occur in a display when a static graphical element is output on the display for a disproportionate of time. By way of example, a smartphone may output on a display a static graphical element that includes the letters “LTE” whenever the smartphone is connected to a Long-Term Evolution wireless communications network. The display of such static graphical elements for such disproportionate periods of time (e.g., the entire amount of time a mobile device is connected to an LTE network) can lead to one or more regions of a display being subject to image retention.

Other examples where image retention may commonly occur include a shortcut icon that is consistently display on a home screen, a graphical home button, a Wi-Fi meter, a colon in a digital clock, a battery status icon, a logo for a media company, or the like.

### SUMMARY

The present disclosure is related to a system and method for calibrating a display of a device to minimize the effect of image retention. In one aspect, the method may include actions such as obtaining data representing a current state of pixels in at least a first region of a display, determining, based on the obtained data, a current pixel calibration associated with the first region of the display, determining a difference between the current pixel calibration and an initial pixel calibration for the pixels in the first region of the display, storing the determined difference between the current pixel calibration and the initial pixel calibration in a memory device, and adjusting a calibration of pixels in a second region of the display based on the determined difference.

According to one innovative aspect of the present disclosure, a method is disclosed that includes actions of obtaining, by a user device, data representing a current state of pixels in at least a first region of a display of the user device, determining, by the user device and based on the obtained data, a current pixel calibration associated with the first region of the display of the user device, determining, by the user device, a difference between the current pixel calibration and an initial pixel calibration for the pixels in the first region of the display of the user device; and adjusting, by the user device, a calibration of pixels in a second region of the display of the user device based on the determined difference between the current pixel calibration and an initial pixel calibration for the pixels in the first region of the display of the user device.

Other aspects include corresponding systems, apparatus, and computer programs to perform the actions of methods, encoded on computer storage devices. For a system of one or more computers to be configured to perform particular operations or actions of a method means that the system has installed on it software, firmware, hardware, or a combination thereof that in operation causes the system to perform the operations or actions of the method. For one or more computer programs to be configured to perform particular operations or actions of a method means that the one or more programs include instructions that, when executed by a data processing apparatus, cause the apparatus to perform the operations or actions.

These and other versions may optionally include one or more of the following features. For instance, in some implementations, obtaining data representing a current state of pixels in at least a first region of the display may include sampling, by the user device, data describing output provided on the display of the user device, determining, by the user device and based on the sampled data, one or more regions of the display of the user device that are subject to image retention, and obtaining, by the user device, data representing a current state of pixels in the one or more regions of the display of the user device that are determined to be subject to image retention.

In some implementations, obtaining data representing a current state of pixels in at least a first region of the display may include receiving, by the user device and from a user of the user device, data identifying one or more regions of the display of the user device that are subject to image retention, and obtaining, by the user device, data representing a current state of pixels in the one or more regions of the display of the user device identified by the received data.

In some implementations, determining, by the user device and based on the obtained data, a current pixel calibration associated with the first region of the display of the user device may include determining, by the user device and based on the obtained data, data indicating a temperature and brightness associated with the pixels in the first region of the display of the user device.

In some implementations, the method may further include accessing, by the user device, a memory device of the user device that stores the initial pixel calibration for the pixels in the first region of the display of the user device, and obtaining, by the user device and from the memory device of the user device, the initial pixel calibration for the pixels in the first region of the display of the user device.

In some implementations, the initial pixel calibration for the pixels in the first region of the display of the user device is a pixel calibration that was determined to exist at a first point in time after the display of the user device was manufactured and before a second point in time before the display of the user device leaves a facility of a display manufacturer.

In some implementations, adjusting a calibration of pixels in a second region of the display of the user device based on the determined difference between the current pixel calibration and an initial pixel calibration for the pixels in the first region of the display of the user device may include altering pixel attributes associated with pixels in the second region of the display of the user device based on the determined difference so that the pixels in the second region in the second region of the display of the user device more closely match pixel attributes of the pixels in the first region of the display of the user device.

In some implementations, the method may further include storing, by the user device, the determined difference between the current pixel calibration and the initial pixel calibration in a memory device of the user device.

These, and other innovative features of the present disclosure, are described in more detail in the corresponding detailed description and in the accompanying drawings.

### BRIEF DESCRIPTION OF THE DRAWINGS

FIG. 1 is a contextual diagram of a user device that highlights aspects of a system for calibrating a display to minimize the effect of image retention.

FIG. 2 is a flowchart of a process for calibrating a display to minimize the effect of image retention.

FIG. 3 is another contextual diagram of a user device that highlights aspects of a system for calibrating a display to minimize the effect of image retention.

FIG. 4 shows an example of a computing device and a mobile computing device that can be used to implement the techniques described here.

### DETAILED DESCRIPTION

The present disclosure is directed towards systems, methods, and apparatus, including computer programs encoded on computer storage mediums, for calibrating a display to minimize the effect of image retention. In some implementations, the present disclosure can identify a first region of a display that may be subject to image retention, e.g., burn-in, and then adjust pixel calibrations of pixels in other regions of the display to minimize the effect of the image retention. The pixel calibration adjustments of pixels in other regions of the display may be based on the difference between a current pixel calibration of the pixels in the first region of the display and an initial pixel calibration for the pixels in the first region of the display. The initial pixel calibration may include the calibration of the pixels in the first region of the display at, or near, a time of manufacture of the display. Pixel calibration settings may include, for example, values describing aspects of time, temperature, and brightness for the pixels.

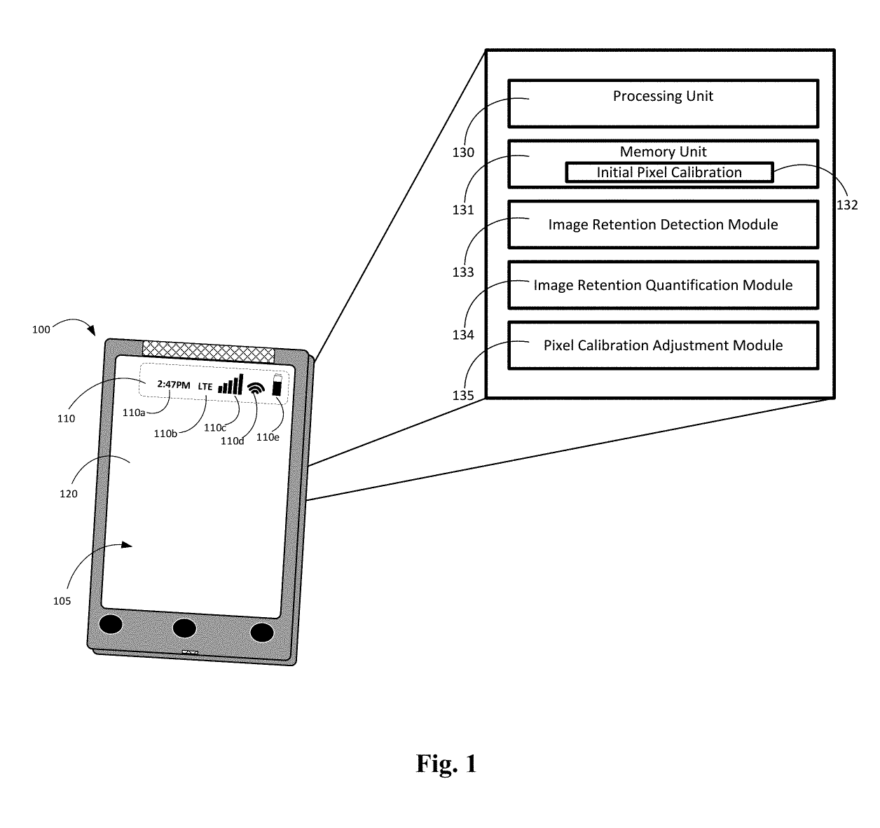

FIG. 1 is a contextual diagram of a user device 100 that highlights aspects of a system for calibrating a display to minimize the effect of image retention. The user device 100 includes a display 105, a processing unit 130, a memory unit 131, an image retention detection module 133, an image retention quantification module 134, and a pixel calibration adjustment module 135. The display 105 may include an OLED display. Each of the respective modules, including the image retention detection module 133, the image retention quantification module 134, and the pixel calibration adjustment module 135 may include set of respective software instructions stored in a memory such as the memory unit 132, or other memory unit, that, when executed by the processor 130, cause the user device 100 to perform the functionality described with respect to each of the respective modules herein.

As a result of the normal operation of the user device 100, one or more regions of the display 105 may be subject to image retention. Any region of the display 105 may be subject to image retention if the region of the display 105 outputs for display a static graphical element for a disproportionate amount of time. Examples of static graphical elements that may be displayed for a disproportionate amount of time may include, for example, a “:” of a digital clock 110a, a cellular network identifier 110b, a cellular network signal strength indicator 110c, a Wi-Fi signal strength indicator 110d, a battery life indicator 110e, or the like.

In some implementations, the user device 100 can use an image retention detection module 133 to detect one or more regions of the display 105 that are subject to image retention. The image retention detection module 133 may be configured to periodically sample data describing the output provided for display on the display 105. The image retention detection module 133 can automatically analyze the sampled data and automatically identify one or more regions of the display 105 that may be subject to image retention. With reference to the example of FIG. 1, the image retention detection module 133 may identify the region 110 as being a region of the display 105 that is subject to image retention. The image retention detection module 133 may identify the region 110 as being subject to image retention based on, for example, image retention detection module 133 a determination that the region 110 of the display 105 is being used to output static graphical elements such as the “:” of a digital clock 110a, a cellular network identifier 110b, a cellular network signal strength indicator 110c, a Wi-Fi signal strength indicator 110d, and a battery life indicator 110e have been output on the display 105 for a disproportionate amount of time when compared to other graphical elements that may be displayed by the display 105.

In other implementations a region of the display 105 that is subject to image retention such as the region 110 may be detected manually by a user of the user device 100. For example, a user may select a region of the display 105 that is subject to image retention. A user may select a region of the display 105 using the user's finger, or a stylus, to draw a circle, oval, square, rectangle, or the like around a region of the display 105 that may be associated with image retention such as the region 110.

The image retention detection module 133 may also be configured to determine a current pixel calibration for the pixels associated with the region 110. Alternatively, one or more other modules may be configured to determine a current pixel calibration for the pixels associated with the region 110. The current pixel calibration may include a description of values over time with respect to temperature, brightness, or both, of the pixels associated with the region 110.

One or more processing units 130 of the user device 100 are access a memory unit of the user device 100 to obtain an initial pixel calibration 132 for one or more regions of the display 105 such as the region 110. In some implementations, the initial pixel calibration 132 for the region 110 may be a pixel calibration that was determined to exist at, or near, the time the display 105 was manufactured. An example of a time near the time of manufacture may include, e.g., a point in time after the display 105 was manufactured but before the display leaves the display manufacturer's facility. The memory unit 131 of the user device 100 that stores the initial pixel calibration 132 for the display 105 may include a flash memory unit associated with a graphical processing unit of the device. Alternatively, the memory unit 133 may include any other form of non-volatile memory unit that can be used to store data such as a semiconductor ROM, read-only memory, or hard disk. In some implementations, the initial pixel calibration 132 may also be stored remotely on a cloud-based server instead of locally on a memory unit 131 of the user device 100. In such implementations, the user device 100 can obtain the initial pixel calibration 132 from the remote cloud-based server when the initial pixel calibration 132 is needed by the user device 100 to perform the processes described herein.

The initial pixel calibration 132 for each region may be determined by using a camera to capture images of the display 105 and then the captured images can be analyzed to determine values related to the time, temperature, and brightness of the display 105 at, or near, the time of manufacture of the display 105 for each of the one or more display regions. The display manufacturer, or other entity, can then adjust the calibration of the pixels in the display 105 based on the initial pixel calibrations 132 for each respective region to create a substantially uniform output across the entire display. However, though this initial calibration of the pixels in one or more region of the display 105 may be accurate at the time of manufacture, the calibration of the pixels in one or more regions of the display 105 of the user device 100 may change over time with respect to temperature, brightness, or both, for one or more regions of the display 105.

The image retention quantification module 134 can determine the difference between the current pixel calibration of pixels in the region 110 and the initial pixel calibration 132 of pixels in the region 110. For example, the image retention quantification module 134 can determine the difference the between the current temperature and current brightness of the pixels in the region 110 and the initial temperature and initial brightness of the pixels in the region 110, respectively. This difference can provide an indication of the change in the pixels of the region 110 as a result of image retention in the region 110.

In some implementations, the user device 100 can store data describing the difference between the current pixel calibration of pixels in the region 110 and the initial pixel calibration 132 in the region 110 in a memory of the user device 100 such as memory unit 131. In some implementations, the memory unit 131 may include a flash storage device of a graphical processing unit of the mobile device 100. In other implementations, the memory unit 131 may include main memory, e.g., RAM, a ROM, a hard disk, or the like. In yet other implementations, the user device 100 may store the data describing the difference between the current pixel calibration and the initial pixel calibration 132 in a memory of a remote cloud-based server. The stored data may be data that describes a difference, over time, of the temperature, brightness, or both, of pixels in the region 110 from the initial pixel calibration to the current pixel calibration. In some implementations, this data may include a pixel gain and offset that may be applied to a current pixel calibration curve in order to achieve a match of the current pixel calibration curve to an average pixel calibration curve as measured on a scale of luminesce versus grays.

Storing the data describing the difference between the current pixel calibration of pixels in the region 110 and the initial calibration of pixels in the region 110 in a flash memory unit of the graphical processing unit of the mobile device 100 may include overwriting the initial pixel calibration with an adjusted pixel calibration that is based on the difference between the current pixel calibration and the initial pixel calibration.

However, the present disclosure is not limited to storing the data describing the difference between the current pixel calibration of pixels in the region 110 and the initial calibration of pixels in the region 110 in a flash memory unit. Instead, such data may be stored in different types of memory. For example, in some implementations, the data describing the difference between the current pixel calibration of pixels in the region 110 and the initial calibration of pixels in the region 110 may be stored in a nonvolatile memory. In some implementations, an adjusted pixel calibration that is based on the difference between the current pixel calibration and the initial pixel calibration may be stored without overwriting the data describing the initial pixel calibration that is stored in a flash memory of a graphical processing unit.

The pixel calibration adjustment module 135 is configured to adjust the calibration of pixels in a different region 120 of the display 105 based on the determined difference between the current pixel calibration of pixels in the region 110 and the initial pixel configuration 132 in the region 110. The adjusted calibration of pixels in the different region 120 of the display 105 will alter pixel characteristics of pixels in the different region 120 so that the pixels in the different region 120 more closely match the pixels in the region 110 that are subject to the effects of image retention. This adjusting of the calibration of pixels in the different region 120 therefore minimizes the impact of the image retention in region 110 that can be perceived by a user of the user device.

In some implementations, when the adjusted pixel calibration based on the difference between the current pixel calibration and the initial pixel calibration 132 is stored in a flash memory unit of a graphical processing unit, the user device 100 may display image data without further modulation of the display data because the adjusted pixel calibration is stored in the flash memory of the graphical processing unit. Alternatively, if the adjusted pixel calibration data is stored in a non-volatile memory, the user device 100 may send modulated display data for display because the initial pixel calibration 132 data is still stored in the flash memory of the graphical processing unit.

The user device 100 of FIG. 1 is an example of a handheld user device such as a smartphone. However, the present disclosure need not be so limited. Instead, the user device 100 may be any user device that includes a display subject to image retention such as OLED displays. Such user devices may include smartphones, smartwatches, tablets, laptops, desktop monitors, televisions, heads-up-displays in a vehicle, or the like.

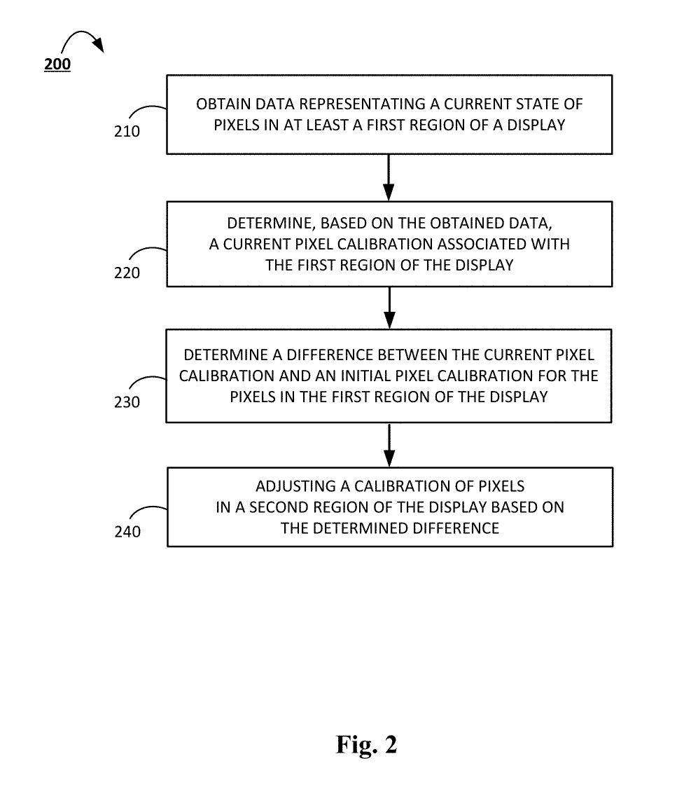

FIG. 2 is a flowchart of a process 200 for calibrating a display to minimize the effect of image retention. Generally, the process 200 may include obtaining data representing a current state of pixels in at least a first region of a display (210), determining, based on the obtained data, a current pixel calibration associated with the first region of the display (220), determining a difference between the current pixel calibration and an initial pixel calibration for the pixels in the first region of the display (230), and adjusting a calibration of pixels in a second region of the display based on the determined difference (240). For convenience, the process 200 will be described as being performed by a user device such as the user device 100 or FIG. 1.

The process may begin with a user device obtaining 210 data representing a current state of pixels in at least a first region of a display of the user device. In some implementations, the user device may periodically obtain data representing the current state of pixels in at least a first region of the display. In other implementations, the user device may continuously obtain data representing a current state of pixels in at least a first region of the display.

The user device may determine 220, based on the obtained data, a current pixel calibration associated with the first region of the display. The current pixel calibration may include an indication of the temperature and brightness associated with the pixels in the first region of the display.

The user device may determine 230 a difference between the current pixel calibration and an initial pixel calibration for the pixels in the first region of the display. For example, the user device can determine the difference the between the current temperature and current brightness of the pixels in the first region of the display and the initial temperature and initial brightness of the pixels in the first region of the display, respectively.

The initial pixel calibration for the pixels in the first region of the display may be based on a calibration of the pixels determined at, or near, the time of manufacturing the display. For example, the initial pixel calibration may include data describing the temperature and brightness of the first region of the display at, or near, the time of manufacturing the display. Data describing this initial pixel calibration may be stored in a memory of the user device. In some implementations, data describing the initial pixel calibration may be stored in flash memory of a graphical processing unit of the user device.

In some implementations, the user device may store data describing the determined difference between the current pixel calibration and the initial pixel calibration in a memory device of the user device. In some implementations, the memory device may include a flash memory of the graphical processing unit of the user device. In some implementations, the data describing the determined difference between the current pixel calibration and the initial pixel calibration may be stored as an adjusted pixel calibration that replaces the initial pixel calibration. Alternatively, in other implementations, the data describing the determined difference between the current pixel calibration and the initial pixel calibration may be stored as an adjusted pixel calibration in a nonvolatile memory. In such instances, the adjusted pixel calibration may be stored without replacing the initial pixel calibration.

The user device may adjust 240 the calibration of pixels in a second region of the display based on the determined difference. The adjusted calibration of pixels in the second region of the display of the user device will alter pixel characteristics of pixels in the second region of the display of the user device so that the pixels in the second region of the display of the user device more closely match the pixels in the first region of the display of the user device that are subject to the effects of image retention. This adjusting of the calibration of pixels in the second region of the display of the user device therefore minimizes the impact of the image retention in the first region of the display of the user device that can be perceived by a user of the user device.

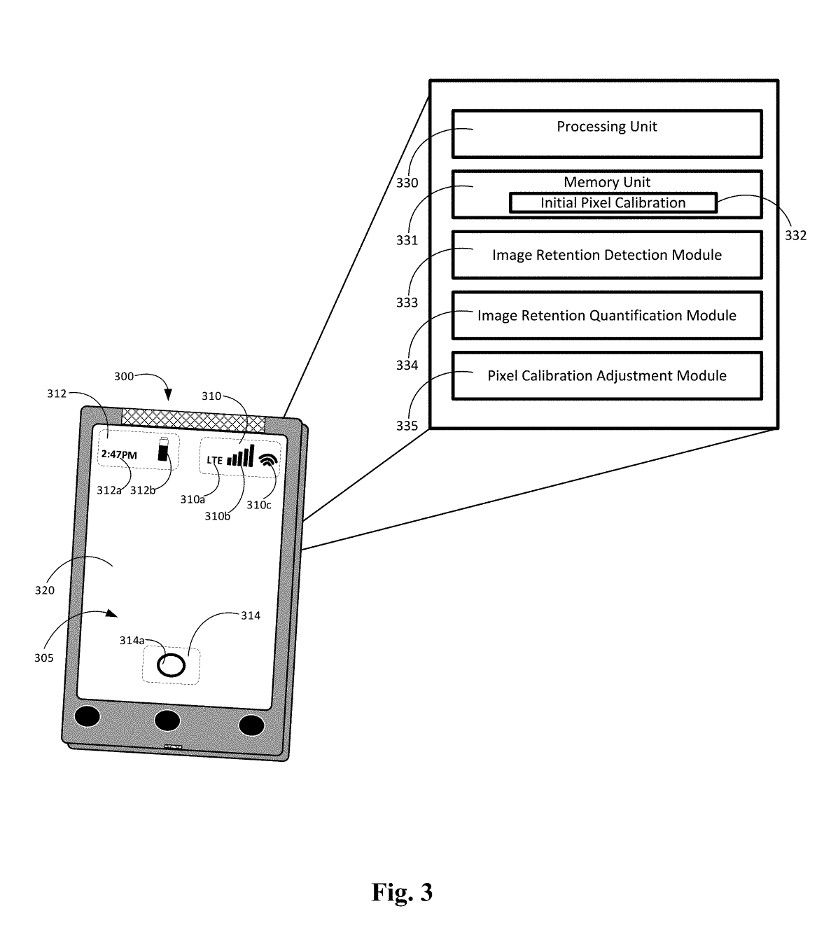

FIG. 3 is another contextual diagram of a user device 300 that highlights aspects of a system for calibrating a display to minimize the effect of image retention. The user device 300 includes a display 305. The user device 300 may also include a processing unit 330, a memory unit 331, an image retention quantification module 334, and a pixel calibration module 335. The display 305 may include an OLED display. Each of the respective modules, including the image retention detection module 333, the image retention quantification module 334, and the pixel calibration adjustment module 335 may include set of respective software instructions stored in a memory such as the memory unit 331, or other memory unit, that, when executed by the processor 330, cause the user device 300 to perform the functionality described with respect to each of the respective modules herein.

The system and method described above with respect to FIGS. 1 and 2, respectively, generally relates to the minimization of image retention that is occurring in a single, contiguous region 110. However, the present disclosure need not be limited to minimizing the effect of image retention that occurs in only a single, contiguous region 110 of a display 105. Instead, the present disclosure can be used to adjust a display 305 to compensate for image retention that is occurring in multiple different, non-contiguous regions of the display 305 of a user device 300.

With reference to FIG. 3, the image retention detection module 333 can identify multiple, non-contiguous regions of the display 305 that are subject to image retention. For example, the image retention detection module 333 can identify a first region 310 that is subject to image retention due to the disproportionate display of the cellular network identifier 310a, the cellular network signal strength identifier 310b, and the Wi-Fi signal strength indicator 310c relative to other graphical items provided by graphical elements provided for display on the display 305. Similarly, by way of example, a second region 312 may be subject to image retention due to the disproportionate display of a “:” of a digital clock 312a and a battery strength indicator 312b. Similarly, by way of example, a third region 314 may be subject to image retention due to the disproportionate display of a virtual home button 314a.

The user device 300 can use each of the respective modules of FIG. 3 including the image retention detection module 133, image retention quantification module 134, and the pixel calibration adjustment module 135 to generally perform the same processes described with reference to FIGS. 1 and 2 in order to obtain first data describing the differences between a current pixel calibration and the initial pixel calibration for the first region 310, second data describing the differences between a current pixel calibration and the initial pixel calibration for the second region 312, and third data describing the differences between a current pixel calibration and the initial pixel calibration 332 for the third region 314. The data describing the differences between the current pixel calibration and initial pixel calibration for each region of the multiple different regions 310, 312, 314 may include data describing a difference in temperature and brightness between the current pixel calibration and initial pixel calibration for each region of the multiple different regions 310, 312, 314.

Then, the image retention quantification module 334, or other module of the user device 300, may be configured to aggregate the determined difference data for each region of the multiple different regions 310, 312, 314. For example, the user device may aggregate the first data describing the differences between a current pixel calibration and the initial pixel calibration for the first region 310, second data describing the differences between a current pixel calibration and the initial pixel calibration for the second region 312, and third data describing the differences between a current pixel calibration and the initial pixel calibration 332 for the third region 314. Aggregated difference data may include a representation of the difference data for each respective region of the multiple different regions 310, 312, 314 that represents an aggregate image retention. By way of example, the image retention quantification module 334, or other module of the user device 300, may determine the average difference between the current pixel calibration and an initial pixel calibration for each respective regions 310, 312, 314. Such an aggregate difference may include, for example, an average change in the temperature and brightness of pixels across each of respective regions 310, 312, 314. Then, the pixel calibration adjustment module 335 can then adjust the calibration of the pixels in the fourth region 320 based on the aggregated difference data.

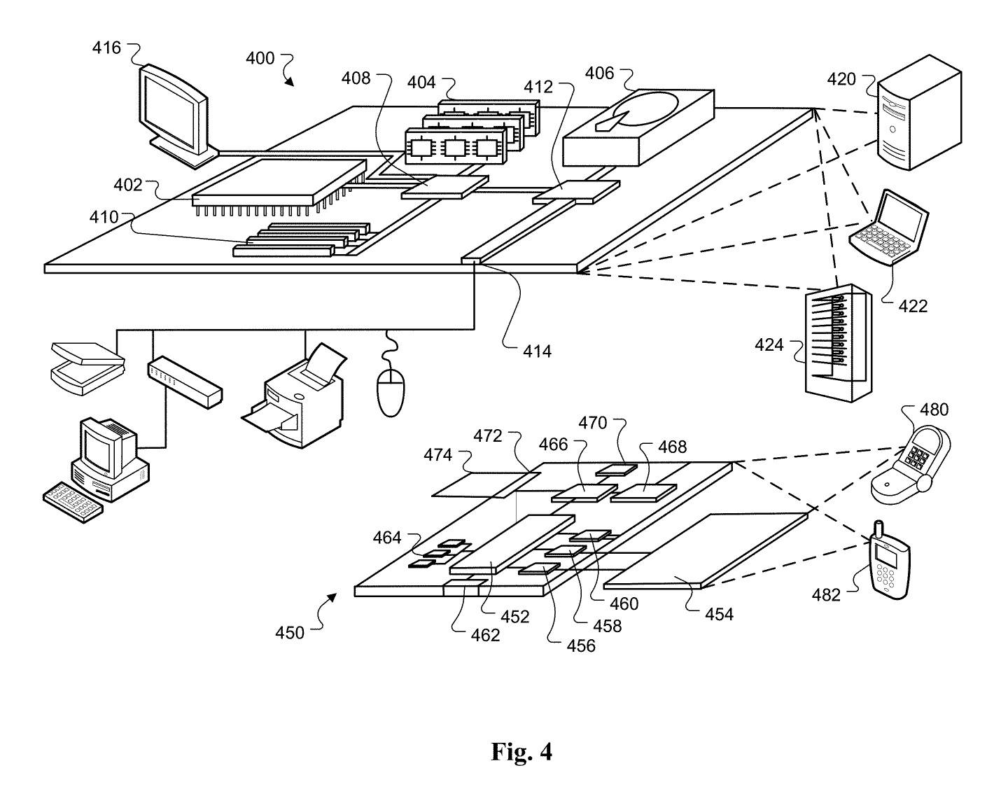

FIG. 4 shows an example of a computing device 400 and a mobile computing device 450 that can be used to implement the techniques described here. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a graphical user interface (GUI) on an external input/output device, such as a display 416 coupled to the high-speed interface 408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine-readable mediums (for example, the memory 404, the storage device 406, or memory on the processor 402).

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device (not shown), such as a mobile computing device 450. Each of such devices may contain one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provided as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as GSM voice calls (Global System for Mobile communications), SMS (Short Message Service), EMS (Enhanced Messaging Service), or MIMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 468 using a radio-frequency. In addition, short-range communication may occur, such as using a Bluetooth, Wi-Fi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

As used herein, the terms “machine-readable medium” “computer-readable medium” refers to any computer program product, apparatus and/or device, e.g., magnetic discs, optical disks, memory, Programmable Logic devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back-end component, e.g., as a data server, or that includes a middleware component such as an application server, or that includes a front-end component such as a client computer having a graphical user interface or a Web browser through which a user can interact with an implementation of the systems and techniques described here, or any combination of such back-end, middleware, or front-end components. The components of the system can be interconnected by any form or medium of digital data communication such as, a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Further to the descriptions above, a user may be provided with controls allowing the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed.

For example, in some embodiments, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

A number of embodiments have been described. Nevertheless, it will be understood that various modifications may be made without departing from the scope of the invention. For example, various forms of the flows shown above may be used, with steps re-ordered, added, or removed. Also, although several applications of the systems and methods have been described, it should be recognized that numerous other applications are contemplated. Accordingly, other embodiments are within the scope of the following claims.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method comprising:
obtaining, by a user device, data representing a current state of pixels in at least a first region of a display of the user device;
determining, by the user device and based on the obtained data, a current pixel calibration associated with the first region of the display of the user device;
determining, by the user device, a difference between the current pixel calibration and an initial pixel calibration for the pixels in the first region of the display of the user device; and
adjusting, by the user device, a calibration of pixels in a second region of the display of the user device based on the determined difference between the current pixel calibration and an initial pixel calibration for the pixels in the first region of the display of the user device.

2. The method of claim 1, wherein obtaining data representing a current state of pixels in at least a first region of the display comprise:
sampling, by the user device, data describing output provided on the display of the user device;
determining, by the user device and based on the sampled data, one or more regions of the display of the user device that are subject to image retention; and
obtaining, by the user device, data representing a current state of pixels in the one or more regions of the display of the user device that are determined to be subject to image retention.

3. The method of claim 1, wherein obtaining data representing a current state of pixels in at least a first region of the display comprises:
receiving, by the user device and from a user of the user device, data identifying one or more regions of the display of the user device that are subject to image retention; and
obtaining, by the user device, data representing a current state of pixels in the one or more regions of the display of the user device identified by the received data.

4. The method of claim 1, wherein determining, by the user device and based on the obtained data, a current pixel calibration associated with the first region of the display of the user device comprises:
determining, by the user device and based on the obtained data, data indicating a temperature and brightness associated with the pixels in the first region of the display of the user device.

5. The method of claim 1, the method further comprising:
accessing, by the user device, a memory device of the user device that stores the initial pixel calibration for the pixels in the first region of the display of the user device; and
obtaining, by the user device and from the memory device of the user device, the initial pixel calibration for the pixels in the first region of the display of the user device.

6. The method of claim 1, wherein the initial pixel calibration for the pixels in the first region of the display of the user device is a pixel calibration that was determined to exist at a first point in time after the display of the user device was manufactured and before a second point in time before the display of the user device leaves a facility of a display manufacturer.

7. The method of claim 1, wherein adjusting a calibration of pixels in a second region of the display of the user device based on the determined difference between the current pixel calibration and an initial pixel calibration for the pixels in the first region of the display of the user device comprises:
altering pixel attributes associated with pixels in the second region of the display of the user device based on the determined difference so that the pixels in the second region in the second region of the display of the user device more closely match pixel attributes of the pixels in the first region of the display of the user device.

8. The method of claim 1, the method further comprising:
storing, by the user device, the determined difference between the current pixel calibration and the initial pixel calibration in a memory device of the user device.

9. A system comprising:
one or more computers and one or more storage devices storing instructions that are operable, when executed by the one or more computers, to cause the one or more computers to perform operations comprising:
obtaining, by a user device, data representing a current state of pixels in at least a first region of a display of the user device;
determining, by the user device and based on the obtained data, a current pixel calibration associated with the first region of the display of the user device;
determining, by the user device, a difference between the current pixel calibration and an initial pixel calibration for the pixels in the first region of the display of the user device; and
adjusting, by the user device, a calibration of pixels in a second region of the display of the user device based on the determined difference between the current pixel calibration and an initial pixel calibration for the pixels in the first region of the display of the user device.

10. The system of claim 9, wherein determining, by the user device and based on the obtained data, a current pixel calibration associated with the first region of the display of the user device comprises:
determining, by the user device and based on the obtained data, data indicating a temperature and brightness associated with the pixels in the first region of the display of the user device.

11. The system of claim 9, the operations further comprising:
accessing, by the user device, a memory device of the user device that stores the initial pixel calibration for the pixels in the first region of the display of the user device; and
obtaining, by the user device and from the memory device of the user device, the initial pixel calibration for the pixels in the first region of the display of the user device.

12. The system of claim 9, wherein the initial pixel calibration for the pixels in the first region of the display of the user device is a pixel calibration that was determined to exist at a first point in time after the display of the user device was manufactured and before a second point in time before the display of the user device leaves a facility of a display manufacturer.

13. The system of claim 9, wherein adjusting a calibration of pixels in a second region of the display of the user device based on the determined difference between the current pixel calibration and an initial pixel calibration for the pixels in the first region of the display of the user device comprises:
altering pixel attributes associated with pixels in the second region of the display of the user device based on the determined difference so that the pixels in the second region in the second region of the display of the user device more closely match pixel attributes of the pixels in the first region of the display of the user device.

14. The system of claim 9, the operations further comprising:
storing, by the user device, the determined difference between the current pixel calibration and the initial pixel calibration in a memory device of the user device.

15. A non-transitory computer-readable medium storing software comprising instructions executable by one or more computers which, upon such execution, cause the one or more computers to perform operations comprising:
obtaining, by a user device, data representing a current state of pixels in at least a first region of a display of the user device;
determining, by the user device and based on the obtained data, a current pixel calibration associated with the first region of the display of the user device;
determining, by the user device, a difference between the current pixel calibration and an initial pixel calibration for the pixels in the first region of the display of the user device; and
adjusting, by the user device, a calibration of pixels in a second region of the display of the user device based on the determined difference between the current pixel calibration and an initial pixel calibration for the pixels in the first region of the display of the user device.

16. The computer-readable medium of claim 15, wherein determining, by the user device and based on the obtained data, a current pixel calibration associated with the first region of the display of the user device comprises:
determining, by the user device and based on the obtained data, data indicating a temperature and brightness associated with the pixels in the first region of the display of the user device.

17. The computer-readable medium of claim 15, the operations further comprising:
accessing, by the user device, a memory device of the user device that stores the initial pixel calibration for the pixels in the first region of the display of the user device; and
obtaining, by the user device and from the memory device of the user device, the initial pixel calibration for the pixels in the first region of the display of the user device.

18. The computer-readable medium of claim 15, wherein the initial pixel calibration for the pixels in the first region of the display of the user device is a pixel calibration that was determined to exist at a first point in time after the display of the user device was manufactured and before a second point in time before the display of the user device leaves a facility of a display manufacturer.

19. The computer-readable medium of claim 15, wherein adjusting a calibration of pixels in a second region of the display of the user device based on the determined difference between the current pixel calibration and an initial pixel calibration for the pixels in the first region of the display of the user device comprises:
altering pixel attributes associated with pixels in the second region of the display of the user device based on the determined difference so that the pixels in the second region in the second region of the display of the user device more closely match pixel attributes of the pixels in the first region of the display of the user device.

20. The computer-readable medium of claim 15, the operations further comprising:
storing, by the user device, the determined difference between the current pixel calibration and the initial pixel calibration in a memory device of the user device.
